(19) United States
(12) Patent Application Publication
(10) Pub. No.: US 2009/0046171 A1
(43) Pub. Date: Feb. 19, 2009

(54) NON-LINEAR COLOR CORRECTION

(75) Inventors: Simon Kogan, Nahariya (IL); Doron Adler, Haifa (IL); Stuart Wolf, Yokneam (IL); Michael Lavrentiev, Nesher (IL)

Correspondence Address: GANZ LAW, P.C., P O BOX 2200, HILLSBORO, OR, 97123, US

(73) Assignee: C2Cure, Inc., Wilmington, DE (US)

(21) Appl. No.: 11/840,183

(22) Filed: Aug. 16, 2007

(51) Int. Cl. G09G 5/02

(52) U.S. Cl. 348/223.1; 382/167; 348/E17.002

(57) ABSTRACT

A method for imaging includes defining a set of one or more color correction parameters having values that vary over a predefined color space. For each of the pixels in an input image, the location of the respective input color is determined in the color space, and a value of the one or more color correction parameters is selected responsively to the location. The respective input color is modified using the selected value so as to produce a corrected output color of the pixel in an output image.

### FIELD OF THE INVENTION

The present invention relates generally to electronic imaging, and specifically to enhancing color reproduction in electronic image capture devices.

### BACKGROUND OF THE INVENTION

The human eye has blue, green and red color receptors, whose spectral sensitivities determine how human beings perceive color. The CIE 1931 RCB color matching functions define the color response of a “standard observer.” Image sensors and electronic imaging cameras use color filters that attempt to approximate this color response, but some residual difference nearly always remains. As a result, the colors in an image of a scene that is created by the sensor or camera tend to differ from the colors that are perceived directly by a human observer looking at the scene itself.

In some systems, digital color correction is used to compensate for this sort of color inaccuracy. For example, U.S. Pat. No. 5,668,956, whose disclosure is incorporated herein by reference, describes a technique for color correction utilizing customized matrix coefficients for a particular imaging device. A digital imaging device, which includes a color sensor, captures an image and generates a color signal from the image for application to an output device having specific color sensitivities. By providing a set of matrix coefficients uniquely determined for this imaging device, the color correction is said to optimally correct the spectral sensitivities of the color sensor and the spectral characteristics of the optical section of the imaging device for the color sensitivities of the output device.

### SUMMARY OF THE INVENTION

Embodiments of the present invention that are described hereinbelow provide improved methods and devices for digital correction of image color. These embodiments apply a color correction that is non-linear, in the sense that the correction cannot be represented by a set of matrix coefficients that are constant over the color space in question. Rather, corrections of hue and saturation for multiple different reference hues are determined in a calibration procedure for a given image sensor. Hue and saturation corrections for other hues are typically determined by interpolation, and are applied in correcting the color values that are output by the image sensor in actual use. This technique can achieve greater color fidelity that linear methods that are known in the art.

There is therefore provided, in accordance with an embodiment of the present invention, a method for imaging, including:

defining a set of one or more color correction parameters having values that vary over a predefined color space;

receiving an input image including pixels, each pixel having a respective input color;

for each of the pixels, determining a location of the respective input color in the color space, selecting a value of the one or more color correction parameters responsively to the location, and modifying the respective input color using the selected value so as to produce a corrected output color; and

generating an output image in which the pixels have the corrected output color.

In disclosed embodiments, defining the set of the one or more color correction parameters includes calibrating an imaging device so as to determine respective reference values of the one or more color correction parameters at a set of reference points in the color space, and selecting the value includes computing the value by interpolation among the reference values responsively to distances of the reference points from the location. Typically, calibrating the imaging device includes capturing respective images, using the imaging device, of a group of test colors, and comparing color coordinates in the respective images to standard color coordinates of the test colors in order to determine the reference values of the one or more color correction parameters.

Additionally or alternatively, computing the value includes determining respective reference phases of the reference points in the color space, determining an input phase of the location in the color space, identifying two of the reference points for which the respective reference phases are closest to the input phase among the group of the reference points, and computing the value as a weighted sum of the reference values at the identified reference points.

In some embodiments, determining the location includes calculating an input hue and an input saturation of the pixel, and the color correction parameters are selected from a group of correction parameters consisting of a hue correction parameter and a saturation correction parameter. Typically, the input hue is represented as a phase in the color space, and the hue correction parameter includes a phase shift, while the input saturation is represented as an amplitude in the color space, and the saturation correction parameter includes a saturation gain, which may be determined as a function of the input hue. Additionally or alternatively, calculating the input hue includes computing a phase of the input color in the color space, and selecting the value includes determining the value of the one or more color correction parameters as a function of the phase.

There is also provided, in accordance with an embodiment of the present invention, imaging apparatus, including:

an image sensor, which is configured to generate an input image including pixels, each pixel having a respective input color; and

image processing circuitry, which is coupled to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.

There is additionally provided, in accordance with an embodiment of the present invention, an imaging device, including:

a color space converter, which is coupled to receive an input image including pixels, and to determine a respective input color for each pixel; and

image processing circuitry, which is coupled to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.

There is further provided, in accordance with an embodiment of the present invention, a computer software product, including a computer-readable medium in which program instructions are stored, which instructions, when read by a processor, cause the processor to receive an input image including pixels, each pixel having a respective input color, and to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an electronic imaging camera, in accordance with an embodiment of the present invention;

FIG. 2 is a plot showing application of hue and saturation corrections in a CbCr color plane, in accordance with an embodiment of the present invention; and

FIG. 3 is a flow chart that schematically illustrates a method for nonlinear color correction, in accordance with an embodiment of the present invention.

### DETAILED DESCRIPTION OF EMBODIMENTS

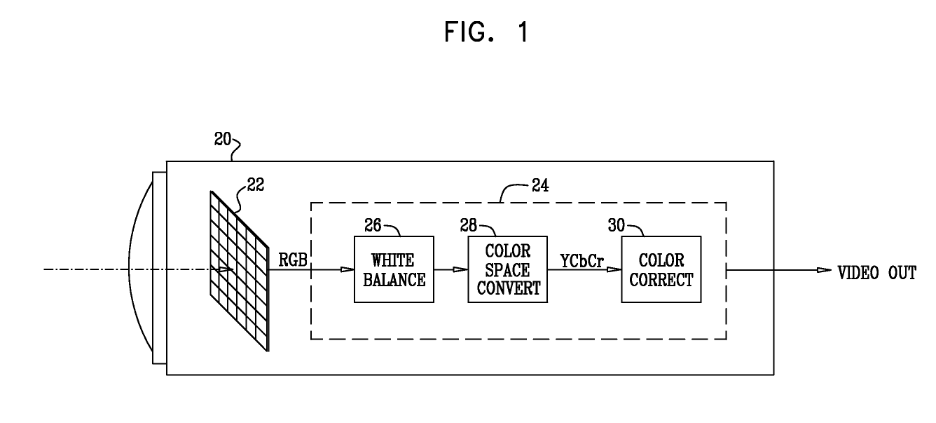

FIG. 1 is a block diagram that schematically illustrates an electronic imaging camera 20, in accordance with an embodiment of the present invention. This camera is described here by way of the example, and the methods described hereinbelow may similarly be applied to electronic imaging devices and systems of other types. Camera 20 comprises an image sensor 22 and image processing circuitry 24. Sensor 22 is assumed to be a color mosaic sensor array, in which each sensor element is overlaid by a red, green or blue color filter, as is known in the art. Alternatively, the method of color correction that are described hereinbelow may be applied, mutatis mutandis, to image sensors with other types of mosaic and stripe filters, as well as to multi-sensor cameras, in which each sensor receives light of a different color.

Image processing circuitry 24 converts the electrical signals that are output by the elements of sensor 22 into video or digital still output images. For the sake of simplicity, FIG. 1 shows only certain functional components of circuitry 24 that pertain directly to color correction. Other functional components of the image processing circuitry that are needed for complete functionality of the camera will be apparent to those skilled in the art and are beyond the scope of the present invention. Furthermore, although circuitry 24 is shown in FIG. 1 as part of camera 20, some or all of the functions of this circuitry may alternatively be carried out by components outside the housing of the camera itself. The functions of circuitry 24 may be implemented in dedicated hardware circuits, such as one or more custom or semi-custom integrated circuit devices. Alternatively, some or all of the functions shown in FIG. 1 may be implemented in software on a microprocessor or other programmable processing device. The software may be downloaded to the microprocessor or other device in electronic form, over a network, for example, or it may alternatively be provided on tangible media, such as optical, magnetic or electronic memory media.

Circuitry 24 typically comprises a white balance block 26, which adjusts the relative gains that are applied respectively to the signals from the red, green and blue sensor elements. The gain coefficients may be set, as is known in the art, by directing camera 20 to image a white surface, measuring the responses of the sensor elements, and then setting the gain coefficients so that the gain-adjusted responses give a white output image. White balance (also referred to as gray balance or color balance) is a type of color correction, but it works simply by applying linear scaling individually to the R, G and B components of the image. White balance block 26 thus provides an input image with input colors in which the primary colors have been balanced, but color distortions may still exist.

A color space converter 28 transforms the white-balanced R, G, B values into luminance (Y) and chrominance (Cb,Cr) coordinates. Any suitable transformation may be used for this purpose, such as the transformations defined by the ITU-R BT.601 standard of the International Telecommunications Union (formerly CCIR 601), which is incorporated herein by reference. A color correction block 30 modifies the colors by applying a non-linear adjustment to the Cb and Cr values of each pixel, depending on the hue and saturation of the color, in order to give corrected output colors. The hue is defined in terms of a phase in the Cb-Cr plane given by arctan

$$( \frac{Cr}{Cb} ) ,$$

while the saturation is defined as the magnitude \sqrt{Cb²+Cr²}. Thus, for the purpose of color correction, each pair of (Cb,Cr) values is treated as a vector having a magnitude given by the saturation and a phase given by the hue.

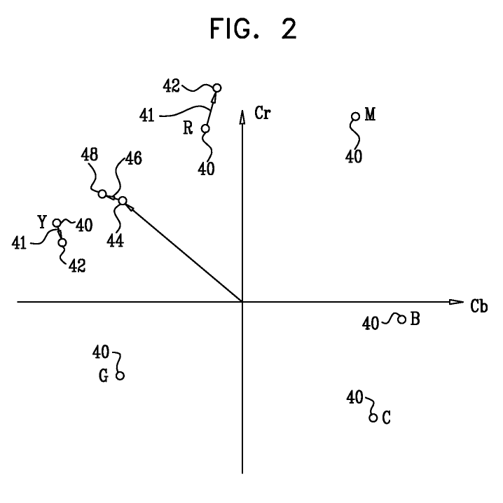

FIG. 2 is a plot showing application of hue and saturation corrections by color correction block 30 in the Cb-Cr color plane, in accordance with an embodiment of the present invention. Six reference points 40 are marked in the plane, corresponding to the measured (Cb, Cr) values for six standard colors: red (R), green (G), blue (B), cyan (C), magenta (M), and yellow (Y). These reference points may correspond to colors in a calibration chart that is used in calibrating the color correction of camera 20, as described hereinbelow. For example, the Macbeth ColorChecker Chart (made by GretagMacbeth A G, Regensdorf, Switzerland) includes these six standard colors. Based upon empirical measurements, the inventors have found that under typical lighting conditions, the standard colors on the Macbeth chart correspond to the following hue (phase) and saturation (magnitude) values:

TABLE I
STANDARD COLOR PHASE AND SATURATION VALUES

| | Predefined Phase | |
|---|---|---|
| Color | (radians) | Predefined saturation |
| Blue | −0.096940 | 11.322135 |
| Green | −2.446040 | 10.180191 |
| Red | 1.852424 | 12.681650 |
| Yellow | 2.821961 | 27.957691 |
| Magenta | 1.159367 | 12.914640 |
| Cyan | −0.763598 | 12.138794 |

The above values are used in the calibration procedure that is described hereinbelow. Alternatively, persons skilled in the art may find that other color calibration targets and other standard hue and saturation values may be more appropriate for other applications.

Camera 20 is calibrated, as described in greater detail hereinbelow, by capturing images of targets of the six standard color on the color chart and computing phase and saturation values based on the camera output, as denoted by points 40. These results are then compared to the standard values in Table I. For each standard color, a correction vector 41 is computed. The vector indicates the corrections Δp and Δs that must be applied to the actual phase and saturation values that are generated by the image sensor, as identified by point 40, so that the color at the camera output will match a reference point 42, corresponding to the standard phase and saturation values for the color in question. (For simplicity, only the red and yellow corrections are shown in FIG. 2.) For convenience and simplicity, the correction parameters are defined as follows:

Phase shift Δp=P_{REF}−P_{SENSOR}

Saturation gain Δs=S_{REF}/S_{SENSOR}

wherein P and S represent the phase and saturation, respectively, for each reference point and the corresponding actual point measured by the sensor. Alternatively, other mathematical representations of the corrections may be used.

In operation of the camera, color correction block 30 computes the phase and saturation values for each pixel based on the input (Cb,Cr) values, and then finds the two closest reference colors. Given the arrangement of the standard colors in the plane shown in FIG. 2, the phase alone may be used to find the closest reference colors, without resort to the saturation. For example, given an orange-colored pixel represented by a point 44 in the color plane, color correction block 30 will identify red and yellow as the two closest reference colors. Block 30 will then determine phase and saturation corrections, Δp′ and Δs′, to be applied to this pixel by linear interpolation between the respective corrections recorded for red and yellow in the calibration phase. The interpolation weights depend on the respective phase differences between the reference colors and point 44.

As a result of this interpolation, color correction block 30 computes a correction vector 46, which it applies to the input phase and saturation values of point 44 in order to generate a corrected output point 48.

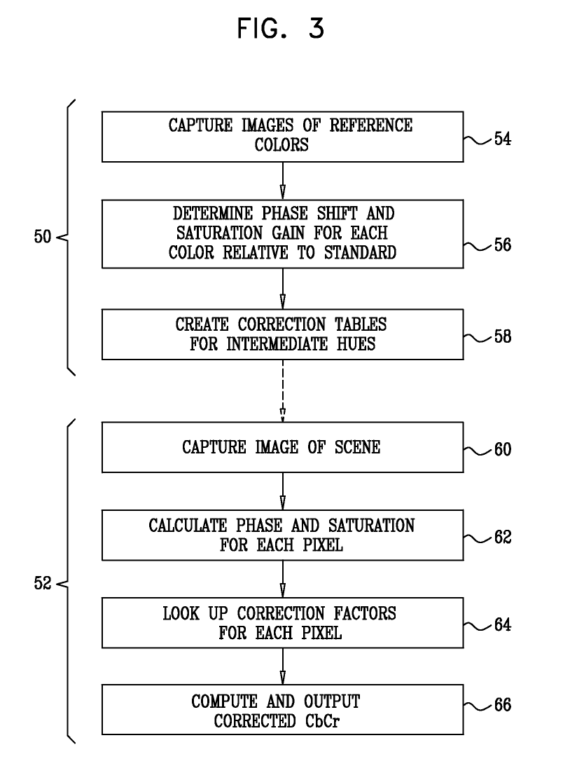

FIG. 3 is a flow chart that schematically illustrates a detailed implementation of the method for nonlinear color correction that is described above, in accordance with an embodiment of the present invention. As noted previously, the method includes a calibration phase 50, followed by a correction phase 52. During the calibration phase, camera 20 is operated to capture images of known reference colors, such as those listed above in Table I, at a reference capture step 54. Based on the camera output, the phase and saturation values of the pixels in the images of the reference colors are compared to the known, standard values, in order to determine respective phase shift and saturation gain values for each color, at a correction determination step 56.

These correction values are used in building correction tables, at a tabulation step 58, for subsequent use in correction phase 52. Assuming six reference colors, as described above, the basic correction table (referred to as corrTbl) will hold 2×6 bytes and will contain the values of Δp and Δs for each of the reference colors. The size of this table and of other correction tables described hereinbelow, however, is stated solely by way of example, and the method of FIG. 3 may be implemented using different, larger or smaller tables depending on application requirements and constraints. The basic correction table is typically stored in memory in camera 20 for use by color correction block 30 in determining corrections for other colors by interpolation.

In addition to the basic correction table, a number of related tables may be prepared in advance in order to reduce the computational burden and increase the speed of determining phase and saturation corrections in the correction phase. A interpolated correction table used by color correction block 30, named ccInterpTbl, contains precalculated values of the interpolated phase and saturation correction parameters for all phases (to within a predetermined resolution) over the 2π range of the (Cb,Cr) plane. The correction values are calculated in advance, based on the values in corrTbl, so that no actual interpolation computation is required in real time. For each phase p, the correction parameters Δp(p) and Δs(p) are precalculated by linear interpolation according to the phase distances:

$$Δ p ( p ) = \frac{A p ( p\_b ) \vert p - p\_a \vert + Δ p ( p\_a ) \vert p - p\_b \vert}{\vert p\_a - p\_b \vert} \\ Δ s ( p ) = \frac{A s ( p\_b ) \vert p - p\_a \vert + Δ s ( p\_a ) \vert p - p\_b \vert}{\vert p\_a - p\_b \vert} \qquad ( 1 )$$

wherein p_a and p_b are the phases of the standard colors that are closest to p (one in the clockwise direction and the other counterclockwise).

To simplify the correction computation even further, the entries in ccInterpTbl may be stored as pairs of eight-bit numbers representing, for each phase p, the values of cos (Δp(p))*Δs(p) and sin (Δp(p))*Δs(p). Color correction block 30 will then be able to compute the new Cb and Cr values for each pixel in correction phase 52 using the multiply-and-add operations:

$${[ \begin{matrix}Cr \\ Cb\end{matrix} ]}_{new} = [ \begin{matrix}cos ( Δ p ( p ) ) * Δ s ( p ) & sin ( Δ p ( p ) ) * Δ s ( p ) \\ - sin ( Δ p ( p ) t ) * Δ s ( p ) & cos ( Δ p ( p ) ) * Δ s ( p )\end{matrix} ] [ \begin{matrix}Cr \\ Cb\end{matrix} ] \qquad ( 2 )$$

The values in ccInterpTbl are computed and stored according to equations (1) and (2) for a limited number of angular values, such as 408 possible phase values distributed over all four quadrants of the (Cb,Cr) plane, i.e., 102 values per quadrant. (This particular number of phases used per quadrant is the result of multiplying the phase values, in radians, by 64, and then rounding to integer values. The inventors have found that it gives satisfactory color correction results without unduly burdening the memory resources of camera 20. Alternatively, higher or lower resolution could be used, depending on application requirements.) During the correction phase, color correction block 30 will determine the phase value for each pixel, and will then use this value as an index to look up the appropriate correction values.

In order to simplify look-up of the correction values in ccInterpTbl, the phase value for each possible pair of values (Cb,Cr) may also be computed in advance and stored in a table, named phaseSelectTbl. Alternatively, phaseSelectTbl may contain index values, which are used to point both to the appropriate entries in ccInterpTbl and to the actual phase values in another table, named phaseTbl. This latter table is useful in computing the entries in ccInterpTbl, but it is not needed during correction phase 52 in the implementation scheme that is described here, and thus need not be stored in the camera.

The phase values for each (Cb,Cr) pair are given by arctan

$$( \frac{Cr}{Cb} ) ,$$

as defined above. Because of the symmetry of the arctangent function, it is sufficient that phaseSelectTbl hold the phase values (or corresponding indices) for (Cb,Cr) values in the first quadrant (Q1), indexed by the absolute values of Cb and Cr. The phase values for the remaining quadrants may be determined from the first-quadrant value phaseSet_Q1 using the formulas:

phaseSet_{—}Q2=−phaseSet_{—}Q1+π

phaseSet₁₃ Q3=phaseSet_{—}Q1−π

phaseSet_{—}Q4=−phaseSet_{—}Q1 (3)

Furthermore, given the angular resolution and indexing of ccInterpTbl, the phase values used in computations and look-up should be scaled to the same 102 values per quadrant as ccInterpTbl. For this purpose, the actual Q1 phase values (in radians, between 0 and π/2) may be multiplied by 64 and then truncated to give integer values between 0 and 101.

For rapid, efficient lookup, while reducing memory requirements, the absolute values |Cb| and |Cr| may be scaled to give six-bit integer indices for lookup in phaseSelectTbl, which thus will hold 64×64 bytes. Each entry in phaseSelectTbl contains a value indicating the first-quadrant phase given by arctan

$$( \frac{\vert Cr \vert}{\vert Cb \vert} ) ,$$

which in turn serves as an index, together with the quadrant value determined by the signs of Cb and Cr, to one of the 408 two-byte entries in ccInterpTbl. After computation of the values of the entries in ccInterpTbl, according to equations (1) and (2), this table may be stored in the memory of camera 20, along with phaseSelectTbl.

Returning now to FIG. 3, after the correction tables have been built at step 58, camera 20 is ready to apply correction phase 52 in imaging of actual objects. The correction may be applied to all pixels in each image captured by the camera, at an image capture step 60, or only to certain images and/or certain pixels. After white balancing, color space converter 28 calculates Cb and Cr values for each pixel. Color correction block 30 then converts the Cb and Cr values to phase and saturation values, at a calculation step 62. For this purpose, the quadrant of the phase is defined by the respective signs of the Cb and Cr values, using formulas (3) above. The absolute values of Cb and Cr are used to look up the phase (or phase index) in phaseSelectTbl, as explained above. Prior to lookup in phaseSelectTbl, |Cb| and |Cr| are scaled to the resolution of the table (in this case, six bits), i.e., the binary values of |Cb| and |Cr| are shifted so that the larger of the two values falls between binary 100000 and 111111.

For each pixel, color correction block 30 uses the phase index from phaseSelectTbl and the phase quadrant to look up the applicable correction factors in ccInterpTbl, at a lookup step 64. These correction factors are applied to the actual Cb and Cr values to compute new, corrected values using equation (2), at a correction step 66. The color correction block outputs the corrected Cb and Cr values, or may alternatively recombine these corrected chrominance value with the luminance Y in order to generate corrected R, G and B values.

The following example, corresponding roughly to the corrections shown in FIG. 2, will illustrate the operation of the method of FIG. 3. It is assumed that correction determination step 56 produced the following correction parameters for the red (R) and yellow (Y) reference colors, which are stored in corrTbl:

TABLE II
SAMPLE CORRECTION TABLE

| Color | Color Phase p (rad) | Δp (degrees) | Δs |
|---|---|---|---|
| Red | 1.852424 | −5 | 1.5 |
| Yellow | 2.821961 | +3 | 0.9 |

Conversion of a given orange-colored pixel from RCB to YCbCr results in (Y,Cb,Cr) coordinates of (126, −22, 34). The chrominance coordinates fall in phase quadrant Q2 (defined by the signs of Cb and Cr). The absolute values of (Cb, Cr) give (22, 34), which does not require resealing before lookup in phaseSelectTbl. The actual phase value, after rounding to one of the available 408 values corresponding to ccInterpTbl, is 2.5635 rad.

The phase values and correction parameters in Table II give the following correction factors for the point (Cb, Cr)=(−22, 34):

$$\begin{matrix}Δ p ( 2.5635 ) = \frac{+ 3 * \vert 2.5635 - 1.852424 \vert + ( - 5 ) * \vert 2.5635 - 2.821961 \vert}{\vert 2.821961 - 1.852424 \vert} \\ = 0.8671 ° \\ Δ s ( 2.5635 ) = \frac{0.9 * \vert 2.5635 - 1.852424 \vert + 1.5 * \vert 2.5635 - 2.821961 \vert}{\vert 2.821961 - 1.852424 \vert} \\ = 1.06\end{matrix}$$

The values stored in ccInterpTbl at step 58 will then be:

cos (Δp(p))*Δs(p)=1.0599

sin(Δp(p))*Δs(p)=0.016

Using (Cb, Cr)=(−22, 34), color correction block 30 looks up these values at step 64, and then computes the following output values of Cr and Cb at step 66:

$${[ \begin{matrix}Cr \\ Cb\end{matrix} ]}_{new} = [ \begin{matrix}1.0599 & 0.016 \\ - 0.016 & 1.0599\end{matrix} ] [ \begin{matrix}34 \\ - 22\end{matrix} ] = [ \begin{matrix}36 \\ - 24\end{matrix} ] .$$

Although the examples presented above relate, for the sake of clarity, to a very specific set of reference colors and correction parameters, the principles of non-linear color correction that are set forth hereinabove may similarly be applied using other color space models and different definitions of the correction parameters. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for imaging, comprising:
defining a set of one or more color correction parameters having values that vary over a predefined color space;
receiving an input image comprising pixels, each pixel having a respective input color;
for each of the pixels, determining a location of the respective input color in the color space, selecting a value of the one or more color correction parameters responsively to the location, and modifying the respective input color using the selected value so as to produce a corrected output color; and
generating an output image in which the pixels have the corrected output color.

2. The method according to claim 1, wherein defining the set of the one or more color correction parameters comprises calibrating an imaging device so as to determine respective reference values of the one or more color correction parameters at a set of reference points in the color space, and
wherein selecting the value comprises computing the value by interpolation among the reference values responsively to distances of the reference points from the location.

3. The method according to claim 2, wherein calibrating the imaging device comprises capturing respective images, using the imaging device, of a group of test colors, and comparing color coordinates in the respective images to standard color coordinates of the test colors in order to determine the reference values of the one or more color correction parameters.

4. The method according to claim 2, wherein computing the value comprises:
determining respective reference phases of the reference points in the color space;
determining an input phase of the location in the color space;
identifying two of the reference points for which the respective reference phases are closest to the input phase among the group of the reference points; and
computing the value as a weighted sum of the reference values at the identified reference points.

5. The method according to claim 1, wherein determining the location comprises calculating an input hue and an input saturation of the pixel, and wherein the color correction parameters are selected from a group of correction parameters consisting of a hue correction parameter and a saturation correction parameter.

6. The method according to claim 5, wherein the input hue is represented as a phase in the color space, and wherein the hue correction parameter comprises a phase shift.

7. The method according to claim 5, wherein the input saturation is represented as an amplitude in the color space, and wherein the saturation correction parameter comprises a saturation gain.

8. The method according to claim 7, wherein the saturation gain is determined as a function of the input hue.

9. The method according to claim 5, wherein calculating the input hue comprises computing a phase of the input color in the color space, and wherein selecting the value comprises determining the value of the one or more color correction parameters as a function of the phase.

10. Imaging apparatus, comprising:
an image sensor, which is configured to generate an input image comprising pixels, each pixel having a respective input color; and
image processing circuitry, which is coupled to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.

11. The apparatus according to claim 10, wherein the set of the one or more color correction parameters is defined by calibrating the imaging apparatus so as to determine respective reference values of the one or more color correction parameters at a set of reference points in the color space, wherein the value of the one or more color correction parameters is computed by interpolation among the reference values responsively to distances of the reference points from the location.

12. The apparatus according to claim 11, wherein the imaging apparatus is calibrated by capturing respective images, using the imaging apparatus, of a group of test colors, and comparing color coordinates in the respective images to standard color coordinates of the test colors in order to determine the reference values of the one or more color correction parameters.

13. The apparatus according to claim 11, wherein the value of the one or more color correction parameters is computed by determining respective reference phases of the reference points in the color space, determining an input phase of the location in the color space, identifying two of the reference points for which the respective reference phases are closest to the input phase among the group of the reference points, and computing a weighted sum of the reference values at the identified reference points.

14. The apparatus according to claim 10, wherein the image processing circuitry is configured to compute the location by calculating an input hue and an input saturation of the pixel, and wherein the color correction parameters are selected from a group of correction parameters consisting of a hue correction parameter and a saturation correction parameter.

15. The apparatus according to claim 14, wherein the input hue is represented as a phase in the color space, and wherein the hue correction parameter comprises a phase shift.

16. The apparatus according to claim 14, wherein the input saturation is represented as an amplitude in the color space, and wherein the saturation correction parameter comprises a saturation gain.

17. The apparatus according to claim 16, wherein the saturation gain is determined as a function of the input hue.

18. The apparatus according to claim 14, wherein the input hue is represented as a phase of the input color in the color space, and wherein the image processing circuitry is configured to determine the value of the one or more color correction parameters as a function of the phase.

19. An imaging device, comprising:
a color space converter, which is coupled to receive an input image comprising pixels, and to determine a respective input color for each pixel; and
image processing circuitry, which is coupled to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.

20. A computer software product, comprising a computer-readable medium in which program instructions are stored, which instructions, when read by a processor, cause the processor to receive an input image comprising pixels, each pixel having a respective input color, and to process the pixels of the input image using a set of one or more color correction parameters having values that vary over a predefined color space, by determining a location of the respective input color in the color space, selecting a value of the one or more color correction parameters responsively to the location, and modifying the respective input color using the selected value so as to produce a corrected output color, thereby generating an output image in which the pixels have the corrected output color.
